(19) United States
(12) Patent Application Publication
(10) Pub. No.: US 2023/0352662 A1
(43) Pub. Date: Nov. 2, 2023

(54) Cathode for All-Solid-State Battery Comprising Coating Layer-Formed Cathode Active Material and Manufacturing Method Thereof

(71) Applicants: Hyundai Motor Company, Seoul (KR); Kia Corporation, Seoul (KR)

(72) Inventors: Seong Hyeon Choi, Changwon-si (KR); Yong Jun Jang, Seongnam-si (KR); In Woo Song, Gwacheon-si (KR); Sang Heon Lee, Yongin-si (KR); So Young Kim, Jeongeup-si (KR); Sun Ho Choi, Incheon (KR); Mun Seok Chae, Busan (KR); Ho Cheol Shin, Seoul (KR); Sa Heum Kim, Suwon-si (KR); Sang Soo Lee, Goyang-si (KR)

(21) Appl. No.: 18/060,560

(22) Filed: Nov. 30, 2022

(30) Foreign Application Priority Data
Apr. 19, 2022 (KR) 10-2022-0047923

(51) Int. Cl. H01M 4/04; H01M 4/139; H01M 4/62; H01M 4/36; H01M 10/0562

(52) U.S. Cl. CPC H01M 4/366; H01M 4/0402; H01M 4/139; H01M 4/62; H01M 10/0562; H01M 2004/021; H01M 2300/0068

(57) ABSTRACT

In an embodiment a cathode for an all-solid-state battery includes a composite material comprising a cathode active material and a coating layer completely covering a surface of the cathode active material, wherein the coating layer comprises a first solid electrolyte and a second solid electrolyte.

### CROSS-REFERENCE TO RELATED APPLICATIONS

This application claims the benefit of Korean Pat. Application No. 10-2022-0047923, filed on Apr. 19, 2022, which application is hereby incorporated herein by reference.

### TECHNICAL FIELD

The present disclosure relates to a cathode for an all-solid-state battery, the cathode comprising a cathode active material whose surface is completely covered with a coating layer comprising a solid electrolyte, and a manufacturing method thereof.

### BACKGROUND

Since the cathode of an all-solid-state battery consists only of solid components such as a cathode active material, a solid electrolyte, and a conductive material, the electrochemical properties of the all-solid-state battery are significantly inferior compared to those of lithium ion batteries and the like due to the non-uniform interfacial contact between the cathode active material and the solid electrolyte.

In order to overcome this, a method of dissolving a solid electrolyte in a solvent, adding a cathode active material, and drying the resulting product to deposit and coat a solid electrolyte on the surface of the cathode active material has been developed. When the solid electrolyte is coated on the surface of the cathode active material, the contact area between both components is widened and the interface is uniformly formed, thereby enhancing the electrochemical properties of the all-solid-state battery.

However, in the above method, it is necessary to select a specific solvent capable of completely dissolving the solid electrolyte, and there is no choice but to go through a cumbersome process of dissolving the solid electrolyte and then precipitating it again.

### SUMMARY

Embodiments provide a method for forming a coating layer completely covering the surface of a cathode active material to a uniform thickness.

Embodiments provide a cathode for an all-solid-state battery comprising a composite material comprising a cathode active material and a coating layer completely covering the surface of the cathode active material and including a first solid electrolyte; and a second solid electrolyte.

The cathode active material may have a D50 particle size of about 1 µm to 10 µm.

The first solid electrolyte may include a sulfide-based solid electrolyte.

The coating layer may have a thickness of about 0.15 µm to 0.45 µm.

The coating layer may have a volume of about 4 µm³ to 40 µm³,

The composite material may comprise an amount of about 0.74 parts by weight to 10 parts by weight of the coating layer based on 100 parts by weight of the cathode active material.

The cathode may have about 0.15 to 0.55 of a ratio (x₁/x₂) of the x-axis intercept value (x₁) at the start point to the x-axis intercept value (x₂) at the end point of charge transfer resistance derived from the Nyquist plot obtained by measuring the impedances.

The cathode may have a lithium ion conductivity of about 2.5×10⁻⁵ S/cm to 2.5×10⁻⁴ S/cm.

Further embodiments provide a method for manufacturing a cathode for an all-solid-state battery, the method comprising preparing a starting material comprising a cathode active material and a solid electrolyte powder; applying a shear stress to the solid electrolyte powder disposed on the surface of the cathode active material to form a coating layer completely covering the surface of the cathode active material and including a first solid electrolyte resulting from the solid electrolyte powder; and mixing a composite material including the cathode active material and the coating layer with a second solid electrolyte to manufacture an electrode.

The solid electrolyte powder may have a D50 particle size of about 0.5 µm to 3 µm.

The starting material may comprise an amount of about 1 part by weight to 10 parts by weight of the solid electrolyte powder based on 100 parts by weight of the cathode active material.

The manufacturing method may apply a shear stress to the solid electrolyte powder by dry-milling the starting material.

The dry-milling may be repeating 12 to 15 times at 500 RPM to 2,200 RPM for 1 minute to 10 minutes using a Thinky mixer.

The ratio of the solid electrolyte powder that becomes the first solid electrolyte constituting the coating layer may be about 0.74 to 1.

According to the present disclosure, the all-solid-state battery with improved electrochemical properties can be obtained by enabling the interfacial resistance between the cathode active material and the solid electrolyte to be lowered.

The effects of the present disclosure are not limited to the above-mentioned effect. It should be understood that the effects of the present disclosure include all effects that can be inferred from the following description.

### BRIEF DESCRIPTION OF THE DRAWINGS

FIG. 1 shows an all-solid-state battery according to the present disclosure;

FIG. 2 shows a part of a cathode according to the present disclosure;

FIG. 3A shows a composite material of Example 2 with a scanning electron microscope (SEM);

FIG. 3B shows a cathode active material of Comparative Example 1 with a scanning electron microscope (SEM);

FIG. 3C shows a composite material of Comparative Example 2 with a scanning electron microscope (SEM);

FIG. 4 shows a reference diagram for explaining a method of obtaining electrode resistance;

FIG. 5 shows impedances for cathodes according to Examples 1 to 3 and Comparative Examples 1 to 3; and

FIG. 6 shows capacities and capacity retention rates of all-solid-state batteries according to Examples 1 to 3 and Comparative Examples 1 to 3.

### DETAILED DESCRIPTION OF ILLUSTRATIVE EMBODIMENTS

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated.

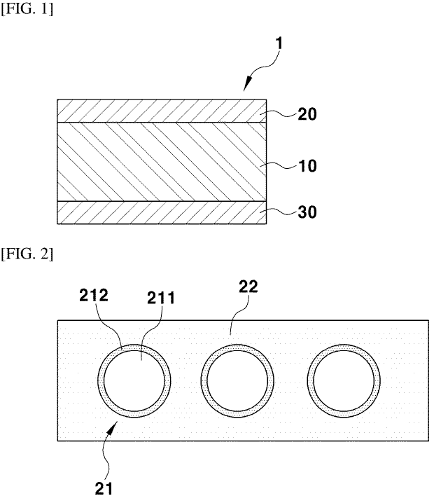

FIG. 1 shows an all-solid-state battery according to the present disclosure. The all-solid-state battery 1 may include a solid electrolyte layer 10, a cathode 20 disposed on one surface of the solid electrolyte layer 10, and an anode 30 disposed on the other surface of the solid electrolyte layer 10.

The solid electrolyte layer 10 may conduct lithium ions between the cathode 20 and the anode 30.

The solid electrolyte layer 10 may include a solid electrolyte.

The solid electrolyte may include an oxide-based solid electrolyte or a sulfide-based solid electrolyte. However, it may be preferable to use a sulfide-based solid electrolyte having high lithium ion conductivity.

The sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (provided that m and n are positive numbers, and Z is one of Ge, Zn, and Ga), Li₂S-GeS₂, Li₂S-SiS₂-Li₃PO₄, Li₂S-SiS₂-LiₓMO_{y} (provided that x and y are positive numbers, and M is one of P, Si, Ge, B, Al, Ga, and In), Li₁₀GeP₂S₁₂, or the like.

FIG. 2 shows a part of a cathode 20 according to the present disclosure. The cathode 20 may include a composite material 21 including a cathode active material 211 and a coating layer 212 formed on the surface thereof; and a second solid electrolyte 22. The cathode 20 may further include a conductive material (not shown), a binder (not shown), and the like.

The present disclosure relates to a method capable of forming a coating layer 212 completely covering the surface of the cathode active material 211. The manufacturing method of the cathode 20 according to the present disclosure may include steps of: preparing a starting material including a cathode active material 211 and a solid electrolyte powder; applying a shear stress to the solid electrolyte powder positioned on the surface of the cathode active material 211 to form a coating layer 212 completely covering the surface of the cathode active material 211 and including a first solid electrolyte derived from the solid electrolyte powder; and mixing a composite material 21 including the cathode active material 211 and the coating layer 212 with a second solid electrolyte 22 to manufacture an electrode 20.

The cathode active material 211 may include any material if it is commonly used in the technical field to which the present disclosure pertains. For example, the cathode active material 211 may include a rock salt layer-type active material such as LiCoO₂, LiMnO₂, LiNiO₂, LiVO₂, LiNi_{0.7}Co_{0.15}Mn_{0.15}O₂, Li₁₊ₓNi_{⅓}Co_{⅓}Mn_{⅓}O₂, or the like, a spinel-type active material such as LiMn₂O₄, Li(Ni_{0.5}Mn_{1.5})O₄, or the like, a reverse spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock salt layer-type active material in which a part of the transition metal is substituted with a dissimilar metal, such as LiNi_{0.8}Co₍_{0.2}₋ₓ₎AlₓO₂ (0<x<0.2), a spinel-type active material in which a part of the transition metal is substituted with a dissimilar metal, such as Li₁₊ₓMn₂₋ₓ₋ _{y}M_{y}O₄ (M is at least one of Al, Mg, Co, Fe, Ni, and Zn, and 0<x+y<2), or a lithium titanate such as Li₄Ti₅O₁₂ or the like.

The cathode active material 211 may have a D50 particle size of about 1 µm to 10 µm. When the D50 particle size of the cathode active material 211 is within the above range, the surface thereof may be completely covered with the coating layer 212 through a process to be described later.

The solid electrolyte powder is a material for forming the coating layer 212, and may include a sulfide-based solid electrolyte. The sulfide-based solid electrolyte may be one which is the same as the solid electrolyte contained in the above-described solid electrolyte layer 10 or may be one which is expressed by Chemical Formula 1 below.

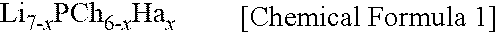

Ch may include at least one of chalcogen elements, preferably sulfur (S).

Ha may include at least one of halogen elements, preferably chlorine (Cl) or bromine (Br).

Chemical Formula 1 may satisfy 0<x≤1.8.

The solid electrolyte powder may have a D50 particle size of about 0.5 µm to 3 µm. Since shear stress is not properly applied when the D50 particle size of the solid electrolyte powder exceeds 3 µm, the solid electrolyte powder may not be coated on the surface of the cathode active material 211 and may agglomerate around the cathode active material 211. Further, pores may be formed between the cathode active material 211 and the coating layer 212 so that an interface may not be properly formed.

The starting material may include an amount of about 1 part by weight to 10 parts by weight of the solid electrolyte powder based on 100 parts by weight of the cathode active material 211. When the solid electrolyte powder falls within the above range, a coating layer 212 completely covering the surface of the cathode active material 211 may be formed.

Thereafter, a shear stress may be applied to the solid electrolyte powder disposed on the surface of the cathode active material 211 by dry-milling the starting material. The solid electrolyte powder subjected to the shear stress may form a coating layer 212 completely covering the surface of the cathode active material 211 while being crushed on the surface of the cathode active material 211.

Specifically, the process of dry-milling the starting material at 500 RPM to 2,200 RPM for 1 minute to 10 minutes using a Thinky mixer may be repeated 12 to 15 times.

Since the Thinky mixer has different directions of rotation and revolution, it is possible to effectively apply the shear stress to the solid electrolyte powder.

The coating layer 212 may have a thickness of about 0.15 µm to 0.45 µm, and a volume of about 4 µm³ to 40 µm³,

A ratio of the first solid electrolyte constituting the coating layer 212 to the solid electrolyte powder may be about 0.74 to 1. That is, when at least 74% of the solid electrolyte powder put as the starting material forms a coating layer 212, the coating layer 212 may completely cover the surface of the cathode active material 211. The measurement method thereof will be described later.

The composite material 21 prepared by the method as described above may be mixed with a second solid electrolyte 22, a conductive material, a binder, and the like, and a cathode 20 may be formed using a mixture thereof. The manufacturing method of the cathode 20 is not particularly limited, and may be a method commonly used in the technical field to which the present disclosure pertains, such as a wet method, a dry method, or the like.

According to the first embodiment of the present disclosure, the anode 30 may include an anode active material and a solid electrolyte.

The anode active material is not particularly limited, but may include, for example, a carbon active material or a metal active material.

The carbon active material may include mesocarbon microbeads (MCMB), graphite such as highly oriented pyrolytic graphite (HOPG), or the like, or amorphous carbon such as hard carbon, soft carbon, or the like.

The metal active material may include In, Al, Si, Sn, or an alloy containing at least one of these elements.

The solid electrolyte may conduct lithium ions within the anode 30. The solid electrolyte may include an oxide-based solid electrolyte or a sulfide-based solid electrolyte. However, it may be preferable to use a sulfide-based solid electrolyte having high lithium ion conductivity.

The sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (provided that m and n are positive numbers, and Z is one of Ge, Zn, and Ga), Li₂S-GeS₂, Li₂S-SiS₂-Li₃PO₄, Li₂S-SiS₂-LiₓMO_{y} (provided that x and y are positive numbers, and M is one of P, Si, Ge, B, Al, Ga, and In), Li₁₀GeP₂S₁₂, and the like.

According to the second embodiment of the present disclosure, the anode 30 may include lithium metal or a lithium metal alloy.

The lithium metal alloy may include lithium and an alloy of a metal or metalloid capable of alloying with lithium. The metal or metalloid capable of alloying with lithium may include Si, Sn, Al, Ge, Pb, Bi, Sb, and the like.

According to the third embodiment of the present disclosure, the anode 30 may not include an anode active material and a component substantially playing the same role as the anode active material. When the all-solid-state battery is charged, lithium ions moved from the cathode 20 are precipitated and stored in the form of lithium metal between the anode 30 and an anode current collector (not shown).

The anode 30 may include amorphous carbon and a metal capable of alloying with lithium.

Amorphous carbon may include at least one selected from the group consisting of furnace black, acetylene black, ketjen black, graphene, and combinations thereof.

The metal may include at least one selected from the group consisting of gold (Au), platinum (Pt), palladium (Pd), silicon (Si), silver (Ag), aluminum (Al), bismuth (Bi), tin (Sn), zinc (Zn), and combinations thereof.

Hereinafter, the present disclosure will be described in more detail through specific Examples. The following Examples are merely examples to help the understanding of the present disclosure, and the scope of the present disclosure is not limited thereto.

### Example 1

A starting material was prepared by mixing 2 parts by weight of a sulfide-based solid electrolyte (Li₆PS₅Cl), which is a solid electrolyte powder, with 100 parts by weight of NCM₇₁₁ (LiNi_{0.7}Co_{0.15}Mn_{0.15}O₂) as a cathode active material. The cathode active material has a D50 particle size of 5.0 µm, and the solid electrolyte powder has a D50 particle size of 1.95 µm.

The starting material was put into a Thinky mixer and dry-milled without a separate solvent to prepare a composite material. The process of dry-milling the starting material for about 3 minutes was repeated 15 times.

23 parts by weight of a second solid electrolyte (Li₆PS₅Cl), 2 parts by weight of a conductive material, and 50 parts by weight of a binder based on 100 parts by weight of the cathode active material were put into the composite material and mixed to obtain a cathode material. A cathode was manufactured by pressing the cathode material at a certain pressure.

After the cathode was laminated with a solid electrolyte layer and an anode, it was placed in a 16φ mold and pressed under a pressure of about 45 MPa to obtain an all-solid-state battery.

### Example 2

A solid electrolyte powder having a D50 particle size of 0.63 µm was used. Except for this, a cathode and an all-solid-state battery were manufactured in the same manner as in Example 1.

### Example 3

A solid electrolyte powder having a D50 particle size of 3.0 µm was used. Except for this, a cathode and an all-solid-state battery were manufactured in the same manner as in Example 1.

### Comparative Example 1

A cathode was manufactured without forming a composite material. Specifically, the same cathode material comprising 100 parts by weight of the cathode active material, 23 parts by weight of the second solid electrolyte, 2 parts by weight of the conductive material, and 50 parts by weight of the binder as in Example 1 was prepared and pressed to a certain pressure to manufacture a cathode.

After the cathode was laminated with the solid electrolyte layer and the anode, it was placed in a 16φ mold and pressed under a pressure of about 45 MPa to obtain an all-solid-state battery.

### Comparative Example 2

A solid electrolyte powder having a D50 particle size of 5.0 µm was used. Except for this, a cathode and an all-solid-state battery were manufactured in the same manner as in Example 1.

### Comparative Example 3

A composite material was prepared by a wet process.

A solution in which 2 parts by weight of the same solid electrolyte powder as in Example 2 was completely dissolved in an ethanol solution was prepared. 100 parts by weight of the same cathode active material as in Example 1 was put into the solution, the temperature was increased to 50° C. at a rate of 1° C./min, and stirring was performed for about 5 minutes. In this process, a solid electrolyte was precipitated on the surface of the cathode active material, and a coating layer was formed.

23 parts by weight of a second solid electrolyte (Li₆PS₅Cl), 2 parts by weight of a conductive material, and 50 parts by weight of a binder were put into the resulting product of the above process based on 100 parts by weight of the cathode active material, and stirring was performed for about 24 hours. After finishing stirring, the solvent was removed by performing vacuum drying at about 150° C. for about 2 hours. A cathode material obtained by the above method was pressurized at a certain pressure to manufacture a cathode.

After the cathode was laminated with the solid electrolyte layer and the anode, it was placed in a 16φ mold and pressed under a pressure of about 45 MPa to obtain an all-solid-state battery.

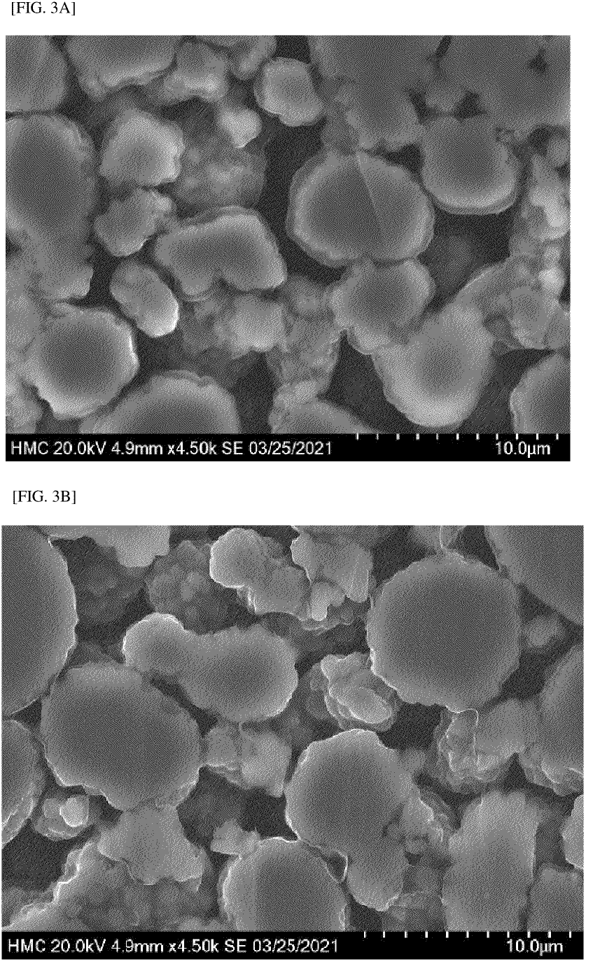

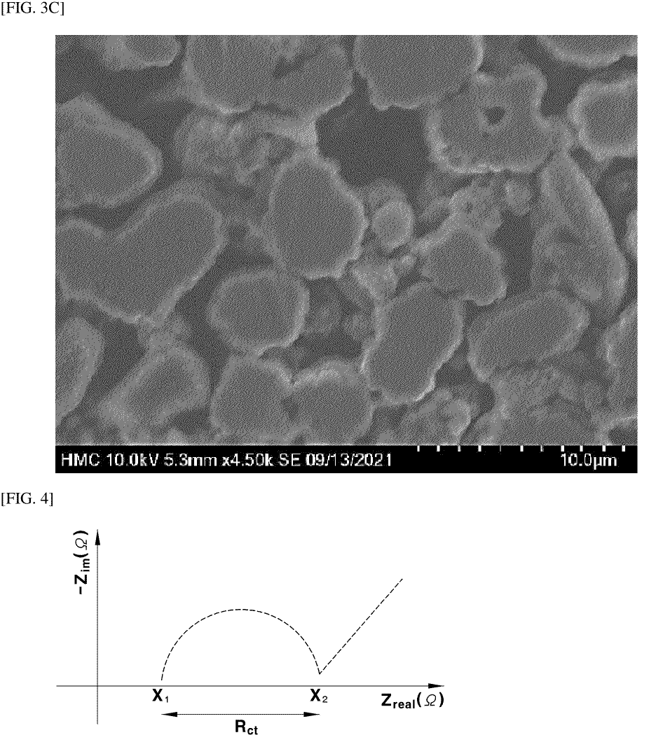

FIG. 3A shows a composite material of Example 2 with a scanning electron microscope (SEM). FIG. 3B shows a cathode active material of Comparative Example 1 with a scanning electron microscope (SEM). FIG. 3C shows a composite material of Comparative Example 2 with a scanning electron microscope (SEM).

Comparing FIG. 3A with FIGS. 3B and 3C, it can be seen that the coating layer is locally formed and does not completely surround the cathode active material in Comparative Examples 2 and 3. In particular, the coating layer is thickly formed on only one side of the cathode active material in a semicircular shape in Comparative Example 2 using a solid electrolyte powder having a large D50 particle size. This is due to the agglomeration phenomenon occurred because the shear stress was not applied properly by using the solid electrolyte powder with a large D50 particle size.

Table 1 below shows results of measuring the physical properties of the composite materials of Examples 1 to 3, Comparative Example 2, and Comparative Example 3.

TABLE 1

| Classification | Coating layer thickness [µm] | Coating layer volume [µm³] | Coating amount¹⁾ |
|---|---|---|---|
| Example 1 | 0.15 | 12.5 | 0.887 |
| Example 2 | 0.2 | 17.0 | 0.807 |
| Example 3 | 0.4 | 36.7 | 0.743 |
| Comparative Example 2 | 0.5 | 47.6 | 0.657 |
| Comparative Example 3 | 0.05 | - | 0.327 |

1) The coating amount means a ratio of the first solid electrolyte constituting the coating layer to the solid electrolyte powder contained in the starting material. When the resulting product of dry milling (Examples 1 to 3 and Comparative Example 2) or stirring (Comparative Example 3) is put into dibromoethane having a density of about 2.17 g/cm³, the solid electrolyte (Li₆PS₅Cl), which does not become a coating layer, drifts upward and the composite material sinks. After removing the drifting solid electrolyte, separating the composite material through filtration, and drying the solvent, when the weight is measured, the ratio of the solid electrolyte powder that became the coating layer can be seen.

Referring to FIG. 3C and Table 1 above, when a solid electrolyte powder having a large D50 particle size is used as in Comparative Example 2, it can be seen that the ratio of the solid electrolyte powder that becomes the coating layer is low, and thus the coating layer cannot completely cover the cathode active material.

Table 2 below shows results of specifying electrochemical properties of the electrodes of Examples 1 to 3 and Comparative Examples 1 to 3.

TABLE 2

| Classification | Electronic conductivity [S/cm] | Lithium ion conductivity | Electrode resistance (x₁/x₂)²⁾ |
|---|---|---|---|
| Example 1 | 2.9×10⁻⁵ | 7.4×10⁻⁵ | 0.282 |
| Example 2 | 4.0×10⁻⁵ | 2.2×10⁻⁴ | 0.154 |
| Example 3 | 3.2×10⁻⁵ | 2.7×10⁻⁵ | 0.540 |
| Comparative Example 1 | 1.1×10⁻⁴ | 2.1×10⁻⁵ | 0.844 |
| Comparative Example 2 | 3.6×10⁻⁵ | 1.8×10⁻⁵ | 0.661 |
| Comparative Example 3 | 1.5×10⁻⁴ | 2.4×10⁻⁵ | 0.862 |

2) The electrode resistance means a ratio (x₁/x₂) of the x-axis intercept value (x₁) at the start point to the x-axis intercept value (x₂) at the end point of the charge transfer resistance (R_{ct}) derived from the Nyquist plot obtained by measuring the impedances as shown in FIG. 4.

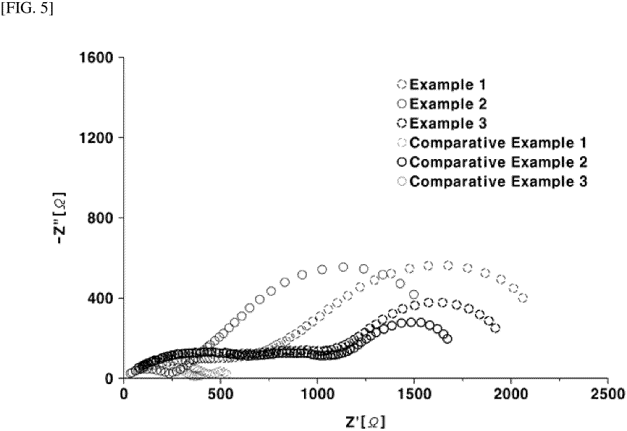

FIG. 5 shows impedances for cathodes according to Examples 1 to 3 and Comparative Examples 1 to 3. Table 2 shows the results of analyzing these according to the definition of the electrode resistance.

It can be seen that the cathode according to the present disclosure has an electrode resistance according to the above definition of 0.15 to 0.55.

Further, according to Table 2, it can be seen that the electrode according to the present disclosure has a lithium ion conductivity of 2.5×10⁻⁵ S/cm to 2.5×10⁻⁴ S/cm.

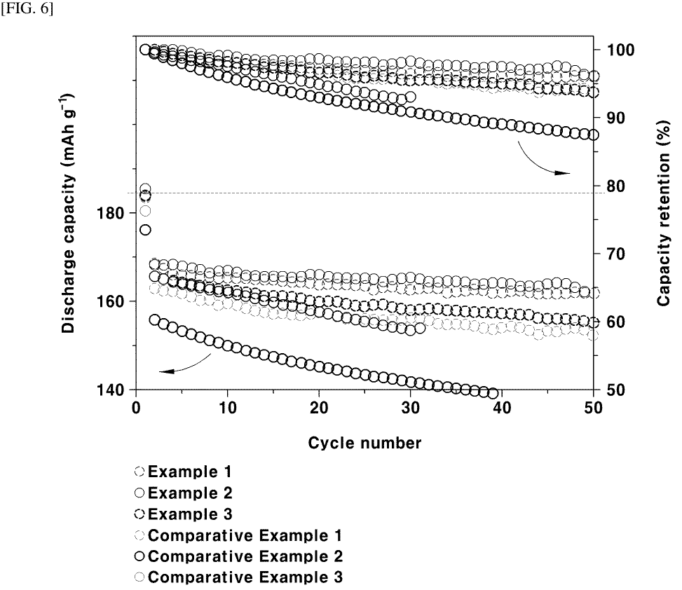

FIG. 6 shows capacities and capacity retention rates of all-solid-state batteries according to Examples 1 to 3 and Comparative Examples 1 to 3. Each result is shown in Table 3 below.

TABLE 3

| Classification | Charge capacity [mAh/g] | Discharge capacity [mAh/g] | 0.5C 1^{st} discharge capacity | 30 cycle capacity retention rate [%] | 100 cycle capacity retention rate [%] |
|---|---|---|---|---|---|
| Example 1 | 215.7 | 183.7 | 168.4 | 96.5 | 94.1 |
| Example 2 | 217.0 | 185.0 | 168.1 | 98.3 | 92.0 |
| Example 3 | 218.3 | 183.9 | 165.4 | 95.5 | 90.7 |
| Comparative Example 1 | 217.5 | 183.8 | 163.2 | 96.0 | 87.2 |
| Comparative Example 2 | 213.6 | 176.1 | 155.7 | 90.6 | 81.1 |
| Comparative Example 3 | 214.8 | 180.3 | 165.5 | 93.0 | - |

Referring to Table 3, the all-solid-state batteries according to Examples 1 to 3 show higher capacities than those of Comparative Examples, and maintain capacities of 90% or more until charging and discharging are repeated 100 times.

Hereinabove, embodiments of the present disclosure have been described with reference to the accompanying drawings, but those with ordinary skill in the art to which the present disclosure pertains will understand that the present disclosure may be implemented in other specific forms without changing the technical spirit or essential features thereof. Therefore, it should be understood that the embodiments described above are illustrative in all respects and not restrictive.

What is claimed is:

1. A cathode for an all-solid-state battery, the cathode comprising:
a composite material comprising a cathode active material and a coating layer completely covering a surface of the cathode active material, wherein the coating layer comprises a first solid electrolyte; and
a second solid electrolyte.

2. The cathode of claim 1, wherein the cathode active material has a D50 particle size of about 1 µm to 10 µm.

3. The cathode of claim 1, wherein the first solid electrolyte comprises a sulfide-based solid electrolyte.

4. The cathode of claim 1, wherein the coating layer has a thickness of about 0.15 µm to 0.45 µm.

5. The cathode of claim 1, wherein the coating layer has a volume of about 4 µm³ to 40 µm³.

6. The cathode of claim 1, wherein the composite material comprises an amount of about 0.74 parts by weight to 10 parts by weight of the coating layer based on 100 parts by weight of the cathode active material.

7. The cathode of claim 1, wherein the cathode has 0.15 to 0.55 of a ratio (x₁/x₂) of an-axis intercept value (x₁) at a start point to an x-axis intercept value (x₂) at an end point of a charge transfer resistance derived from a Nyquist plot obtained by measuring impedances.

8. The cathode of claim 1, wherein the cathode has a lithium ion conductivity of about 2.5 × 10⁻⁵ S/cm to 2.5×10⁻⁴ S/cm.

9. A method for manufacturing a cathode for an all-solid-state battery, the method comprising:
preparing a starting material comprising a cathode active material and a solid electrolyte powder;
applying a shear stress to the solid electrolyte powder disposed on a surface of the cathode active material to form a coating layer completely covering the surface of the cathode active material and comprising a first solid electrolyte derived from the solid electrolyte powder; and
mixing a composite material comprising the cathode active material and the coating layer with a second solid electrolyte to manufacture an electrode.

10. The method of claim 9, wherein the cathode active material has a D50 particle size of about 1 µm to 10 µm.

11. The method of claim 9, wherein the solid electrolyte powder has a D50 particle size of about 0.5 µm to 3 µm.

12. The method of claim 9, wherein the solid electrolyte powder comprises a sulfide-based solid electrolyte.

13. The method of claim 9, wherein the starting material comprises an amount of about 1 part by weight to 10 parts by weight of the solid electrolyte powder based on 100 parts by weight of the cathode active material.

14. The method of claim 9, wherein the shear stress is applied to the solid electrolyte powder by dry-milling the starting material.

15. The method of claim 9, wherein the shear stress is applied to the solid electrolyte powder by dry-milling the starting material at 500 RPM to 2,200 RPM for 1 minute to 10 minutes using a Thinky mixer for 12 to 15 times.

16. The method of claim 9, wherein the coating layer has a thickness of about 0.15 µm to 0.45 µm.

17. The method of claim 9, wherein the coating layer has a volume of about 4 µm³ to 40 µm³.

18. The method of claim 9, wherein a ratio of the solid electrolyte powder that becomes the first solid electrolyte is about 0.74 to 1.

19. The method of claim 9, wherein the cathode has about 0.15 to 0.55 of a ratio (x_{1/}x₂) of an x-axis intercept value (x₁) at a start point to an x-axis intercept value (x₂) at an end point of a charge transfer resistance derived from a Nyquist plot obtained by measuring impedances.

20. The method of claim 9, wherein the cathode has a lithium ion conductivity of about 2.5 × 10⁻⁵ S/cm to 2.5×10⁻⁴ S/cm.
